(19) United States
(12) Patent Application Publication
(10) Pub. No.: US 2006/0121805 A1
(43) Pub. Date: Jun. 8, 2006

(54) Non-woven, uni-directional multi-axial reinforcement fabric and composite article

(76) Inventor: Charlie B. Krulic, Anderson, SC (US)

Correspondence Address: LITMAN LAW OFFICES, LTD, PO BOX 15035, CRYSTAL CITY STATION, ARLINGTON, VA, 22215, US

(21) Appl. No.: 11/005,210

(22) Filed: Dec. 7, 2004

(51) Int. Cl. B32B 5/26; D03D 9/00; B32B 27/12; B32B 17/02

(52) U.S. Cl. 442/20; 442/27; 442/35; 442/36; 442/38; 442/24; 442/32; 442/43; 442/49; 442/54; 442/57; 442/58; 156/307.3; 156/305

(57) ABSTRACT

A non-woven, unidirectional, multi-axial layered fabric for reinforcement of composite structures provides for holding the non-woven yarns as laid-out by adhesion of polymeric adhesive applied to the non-woven yarns. The adhesive layer on the yarns, dissolves as liquid resin is applied to form a composite structure, the polymeric coating dissolving in the liquid resin. The polymeric adhesive dissolves to allow liquid resin to wet the yarns. Curing creates the desired composite structure. Filament yarns useful in the present invention include but are not limited to those made of aramid, boron, carbon, fiberglass, nylon, PBO, PEN, polyester, and polyethylene. A preferred adhesive is low molecular weight polyester and a preferred liquid resin is polyester resin. A web of netting material is applied in a similar manner for added physical stability of the inventive reinforcement fabric.

### BACKGROUND OF THE INVENTION

1. Field of the Invention

The present invention relates to textiles. More particularly, the present invention relates to fabrics useful as reinforcement in composite structures and the resulting structures.

2. Description of the Related Art

A known method of forming reinforced plastics articles and composites is to lay a mat of a non-woven or woven glass fiber or other reinforcement and wet the mat of material with a synthetic resin material, to cure the resin, and to remove the molded article from the mould. When a greater thickness of reinforced composites material is required in the molded article, then further mats of reinforcing material are laid upon the first, wetted, and cured. Also, plates of reinforced composites materials may be formed suitable for cutting to form a desired article. Textile fabric materials useful as reinforcement in such composite structures typically are either woven or stitch-bonded fabrics, using yarns of fibers such as fiberglass, carbon, or aramid (Kevlar) fibers. To form a useful article, each layer of the textile material must be fully wetted by the synthetic resin material before curing to avoid the creation of voids in the article, reducing its strength and integrity.

The advantage of a woven fabric in composite structure is that the fabric is very pliable. This characteristic is advantageous when laying the fabric inside of an open or closed mold, where the resin is either applied or injected. The disadvantage of woven fabric in a composite structure is that a weave creates weak places in the yarn. This is due to how the yarns must go up-and-down in a weave forming crimps. These crimps create weak locations, in the finished composite structure.

For a non-woven fabric, such a stitch-bonded fabric, the yarns are non-crimped, i.e., there is no repeated up-and-down orientation of the yarn as in a woven fabric. The yarns in a non-woven, stitch-bonded fabric can be laid-out in a fabric machine direction (warp of 0 degrees), perpendicular to the machine direction (weft or filling of 90 degrees), or at a +45/−45 degree angle to the machine direction. The yarns in this type of fabric are non-crimped. The disadvantage, however, of this type of fabric is that the warp-knitted yarns may be pulled out during wetting with resin, thereby causing the 0 degree/90 degree/+45 degree/−45 degree yarns to fall apart. To overcome this problem the manufacturers of this type of fabric put addition warp-knitting yarn in place, however this inhibits the flow of liquid resin throughout the fabric to fully wet the fabric as required for a desirable composite structure.

It would be desirable to provide a non-woven fabric for reinforcement of composite structures wherein the non-woven yarns can be laid-out relative to the machine direction +90 degree/−90 degree wherein the yarns are held in place without stitch bonding with the physical integrity to avoid pulling out or attendant resin wetting problems.

Thus a non-woven, unidirectional, multi-axial fabric for reinforcement of composite structures solving the aforementioned problems is desired.

### SUMMARY OF THE INVENTION

The non-woven, unidirectional, multi-axial layered fabric for reinforcement of composite structures of the present invention provides for holding the non-woven yarns as laid-out relative to the machine direction of +90 degree/−90 degree by adhesion of polymeric adhesive applied to the non-woven yarns. The adhesive layer on the yarns dissolves as liquid resin is applied to form a composite structure, the polymeric coating dissolving in the liquid resin. The polymeric adhesive dissolves to allow the resin to wet the yarns, forming new bonds with the yarns and curing to create the desired composite structure. The polymeric adhesive coating is directly applied to first web of yarns by applying the adhesive to the yarn in a finish bath, applying heat to the filament yarn to cure the polymeric coating and cooling to form a cured coating directly on the filament yarn. Then a second layer of polymeric adhesive coated filament yarn is laid on top of the first layer of filament yarn and heat is applied to form a +90 degrees/−90 degrees layer of adhesive film-covered filaments forming layered yarn fabric.

During the resin application process, the resin penetrates the filament fabric layers and uniformly dissolves in the resin, as the filament fabric layers become part of the hardened cured resin matrix. Useful polymeric adhesive materials include but are not limited to low molecular weight acrylic, polyester or polyurethane for the finish bath.

Filament yarns useful in the present invention include but are not limited to those made of aramid, boron, carbon, fiberglass, nylon, PBO, PEN, polyester, and polyethylene.

A web of netting material is applied in a similar manner for added physical stability of the inventive reinforcement fabric. The web of netting material may be applied to the upper surface of the second web and the lower surface of the first web.

In some applications, a single web of coated filament yarn cured with the netting material web is adequate as a composite reinforcement fabric and is within the scope of the present invention.

In some applications, the first and second coated filament yarn webs may be cured and employed as a reinforcement fabric without the netting web and is within the scope of the present invention.

When manufacturing a composite structure, a bottom layer of the inventive reinforcement fabric is laid in a mold and liquid resin is applied. As the resin penetrates the reinforcement fabric (wet out), another layer of the reinforcement fabric is applied over the bottom layer and more liquid resin is added to wet this reinforcement fabric layer. This process is repeated, until the desired thickness is achieved. The netting holds the top layer of filament yarn in place as the liquid resin is applied and penetrates the fabric. When the next layer of reinforcement fabric is added, the bottom layer of filament yarns is held in place between netting material and the newly applied layer of filament yarns.

The netting material is preferably made of fiberglass filament yarns and the netting material held together by a polymeric adhesive coating that also dissolves in the liquid resin. The netting material has negligible effect on the hardened resin matrix composite product.

It is an aspect of the invention to provide improved reinforcement fabric materials and composite products thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a perspective view of a non-woven, unidirectional, reinforcement fabric material having single layer of netting according to the present invention.

FIG. 2 is an exploded perspective view of a non-woven, multi-axial, multi-later reinforcement fabric having upper and lower layers of netting according to the present invention.

FIG. 3A is diagrammatic depiction of a prior art system for application of a film to a unidirectional fabric web by treating in a bath and laying another web on the unidirectional fabric web, treating in a heating zone, and cooled and would on a finish roll.

FIG. 3B is a diagrammatic depiction of a prior art system similar to that of FIG. 3A forming a tacky, netting-covered web.

FIG. 3C is a diagrammatic depiction of a prior art system for making a finished web having crossing layers of unidirectional fabric web, in this case at an angle of 90 degrees.

Similar reference characters denote corresponding features consistently throughout the attached drawings.

### DETAILED DESCRIPTION OF THE PREFERRED EMBODIMENTS

The present invention is non-woven, unidirectional, multi-axial layered fabric for the reinforcement of composite structures. The term non-woven, unidirectional, multi-axial layered fabric is defined as adhering layers of non-woven fabric having filament yarns laid at relative angles, for instance, 0 degrees/90 degrees relative to a fabric-making machine.

The inventive reinforcement fabric employs a first web of coated, of non-woven, unidirectional fabric webs of filaments, the coating being of a low molecular weight polymer adhesive material. The fabric has a second layer of non-woven, unidirectional fabric of filaments having a coating of the same adhesive material upon the filaments thereof and overlaid at an axial angle relative to the first layer of non-woven, unidirectional fabric, the layers of fabric being held by the adhesive between the first layer of fabric and the second layer of fabric. The axial angle is preferably about 90 degrees. Filaments useful in the non-woven, unidirectional fabric include filaments of boron, carbon, and fiberglass, and aramid, nylon, PBO, PEN, polyester and polyethylene polymers. The adhesive film on each layer of non-woven, unidirectional fabric of filaments is formed by treating in a finish bath of a low molecular weight polymer of acrylic, polyester, or polyurethane polymers.

The fabric has a first layer of filament netting overlaid on the second layer of non-woven, unidirectional fabric. The netting layer adheres to the second layer by the adhesive coating applied to the second layer. Upon application of a liquid resin to the non-woven, unidirectional, multi-axial fabric, the liquid resin dissolves the polymer adhesive coating and wets the filaments of the first and second layers of fabric. The resulting fabric is heated to drive off water or other solvent from the finish bath by heating lamps or rollers and then cooled and rolled to form the product inventive reinforcement fabric. The resulting reinforcement fabric exhibits a high degree of wetting by liquid resin when is applied thereto, thus resulting in a superior composite product. Due to the layer or layers of netting, the resulting reinforcement fabric also exhibits physical strength and stability(pulling of fibers) during its manufacture, handling, and during lay-up with resin to form a composite material.

The fabric thus formed may lack physical integrity sufficient to avoid pulling, torqueing, or unraveling of the filaments during application of liquid resin by ordinary means, such as by rollers, to manufacture products. Known methods of retaining the integrity of the non-woven fabric include cross-stitching or knitting which inhibits the wetting of the filaments of the fabric with resin and thus weakens the resulting composite.

The physical integrity of the inventive reinforcement fabric is preferably increased by applying a netting layer over at least one of the upper and lower surfaces of the fabric before the drying step. The netting material acts as a carrier and to assist in the holding-down of the side-by-side yarns during the resin application process. The netting is held in place by the tackiness of the wet polymer film before drying and is bonded to the fabric surfaces during the heating step for drying, and the cooling step, resulting in the finished composite reinforcement fabric product.

The netting material is a woven or non-woven filament fabric formed by knitting of or adhesion between filaments of yarns employing an adhesive film of a low molecular weight polymer of acrylic, polyester, or polyurethane polymers, which will dissolve in a corresponding resin. The spacing of the yarns in the netting material may be within the range of about 5 mm to about 75 mm. The netting material fabric is laid at angles ranging from 0 degrees to 90 degrees with respect to the second layer of non-woven, unidirectional fabric, and preferably at an average angle of about 45 degrees with respect to said second layer of non-woven, unidirectional fabric.

The reinforcement fabric of the present invention may include a second netting layer of filaments laid on the underside of the first layer of non-woven, unidirectional fabric, the netting layer adhering to the second layer by the thin adhesive film thereon. The netting layers of filaments preferably include filaments of fiberglass.

A preferred method of forming the non-woven, unidirectional, multi-axial fabric for the reinforcement of composite structures of the present invention include:

(1) Placing the high-tenacity filament yarns in a creel stand or warp beam;

(2) Drawing the filament yarns through a reed;

(3) Through tension, laying the individual filaments from the reed side-by-side to form a first web of reinforcement material;

(4) treating the first web of reinforcement material in a finish bath forming a thin, tacky adhesive polymeric film thereon;

(5) drawing netting fabric against the web of reinforcement material on either the upper or lower side of the first web forming a unidirectional fiber/netting web;

(6) drawing the resulting unidirectional fiber/netting web over a heating element to flash-off solvent and set the polymeric film to form a product unidirectional filament fabric;

(7) drawing the product fabric through a cooling zone; and

(8) winding the product fabric onto a primary roll.

If desired, the following steps may be taken to form a multi-axial reinforcement fabric material:

(9) placing the primary roll across a second web of side-by-side reinforcement yarns such as the product of step 4, above and repeating the heating and cooling steps of steps 6 and 7, above.

(10) winding the product fabric onto a product roll.

If desired, an additional web of netting fabric may be added by employing a unidirectional fiber/netting web obtained as a product of step (5) above as the second web in step (9) and the resulting product fabric onto a product roll.

Preferably, the netting fabric is added on the upper side of the upper unidirectional fiber/netting web and on the lower side of the second web of step (9) to form a multi-axial, unidirectional product reinforcement fabric having netting webs on both the upper and lower surfaces thereof. The second netting layer of fiberglass filaments provides additional physical stability, the netting layer adhering to the second underside of the first layer by tackiness of the thin film of polymer thereon.

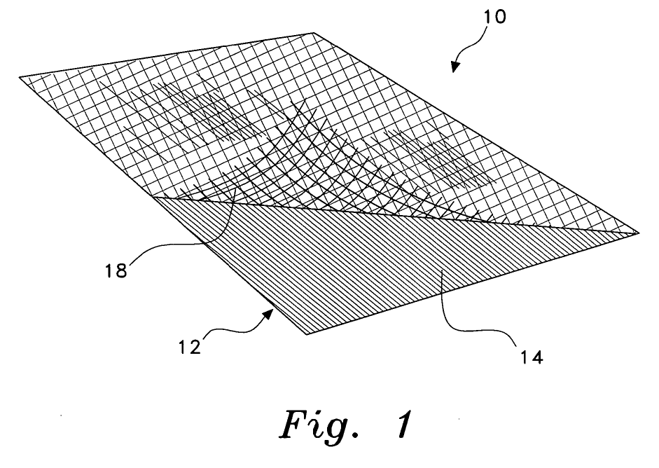

Referring to FIG. 1, there is shown an example of the finished reinforcement fabric of the invention having a single non-woven, unidirectional fabric web covered with a single layer of netting. Reinforcement material 10 is made up of a first longitudinal, non-woven web 12 having a polymeric adhesive coating 14 (not separately shown) thereon, and having a stabilizing netting layer 18 on its upper surface. The netting 18 is fixed on the upper surface of non-woven web 12 during the heating and drying, and curing treatment.

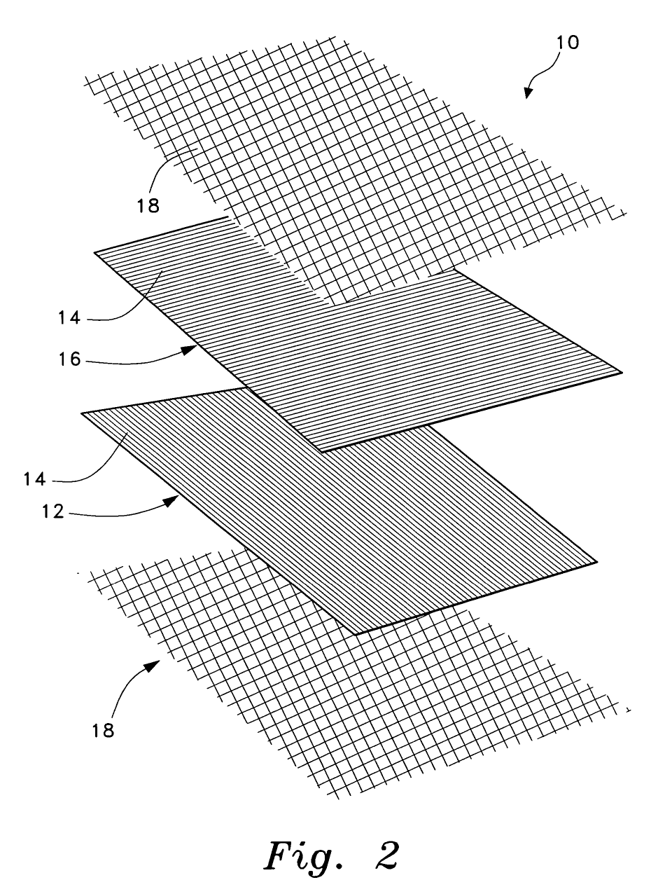

Referring to FIG. 2, there is shown an example of the finished reinforcement fabric 10 of the invention having first non-woven, unidirectional fabric web 12 and second non-woven, unidirectional fabric web 16, each having an adhesive coating 14, the second fabric web 16 being at an axial angle of 90 degrees relative to the first web 12 to form a multi-axial non-woven web, the tackiness of the adhesive binding the two fabric webs together until the curing step. The resulting multi-axial web is covered with a layer of stabilizing netting 18 on the upper side of second fabric web 16 and the lower side of first fabric web 12 in the manner of that of FIG. 1, above. The finished reinforcement fabric 10 is formed by heat drying and curing, and cooling as described above.

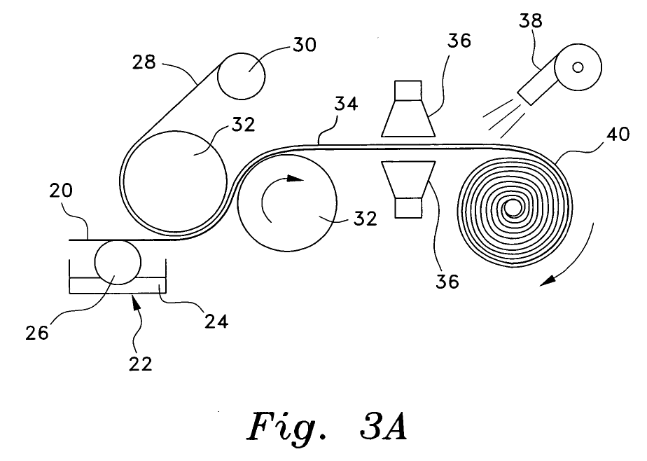

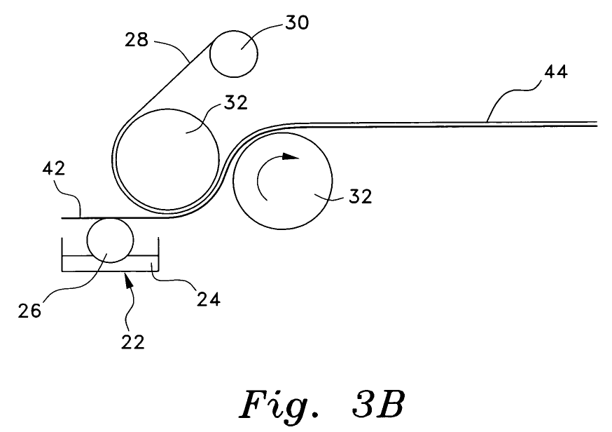

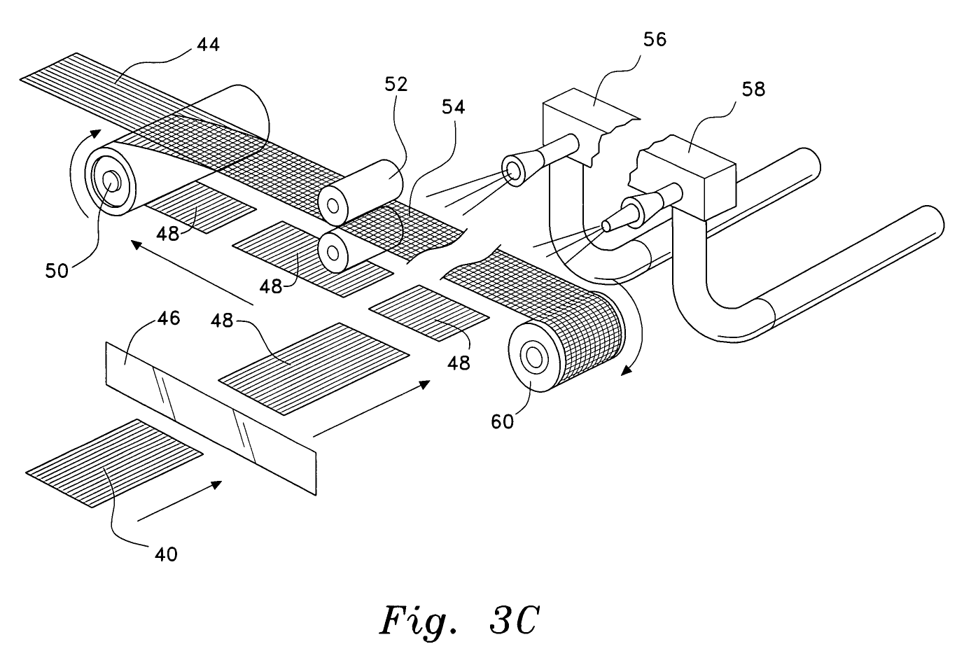

Referring to FIG. 3A there is shown a diagrammatic depiction of a prior art system as described in U.S. Pat. No. 6,425,969, issued Jul. 30, 2002 to van den Akker and hereby incorporated by reference, and adapted for application of a polymeric adhesive coating to a unidirectional fabric web 20 from a creel stand or warp beam and a reed (not shown) by treating with a polymeric adhesive bath 22 having liquid polymer and solvent material 24 applied by rotating roller 26. Netting 28 is unwrapped from netting supply roll 30 and applied to the tacky upper surface of fabric web 20 at rollers 32 to form tacky, netting-covered web 34. Web 34 is treated in a heating zone such as with heat lamps 36 to drive off solvent and cure the polymer on the netting-covered web 34 and then cooled in a cooling zone such as by blower 38 and wound on finish roll 40.

Referring to FIG. 3B, there is shown an adapted prior art system similar to that of FIG. 3A wherein a second longitudinal, non-woven web 42 from a creel stand or warp beam and a reed (not shown) is treated with liquid polymer and solvent material 24 applied by rotating roller 26 as above. Netting 28 is unwrapped from netting supply roll 30 and applied to the tacky upper surface of fabric web 42 at rollers 32 to form a tacky, netting-covered web 44.

Referring to FIG. 3C, there is shown an adapted prior art system of −969 to van den Akker wherein web 40 from finished roll 40 (see FIG. 3A) is cut crosswise into web sections 48 by knife 46 (conveyers not shown) and conveyed to combining roller 50. Tacky, netting-covered web 44 (see FIG. 3B) is combined with web section 48 to a form bi-axial web with pressure rollers 52. The web 54 is drawn through a heating zone, illustrated by hot air heater 56, for flashing off solvent from web 44 and curing the polymer adhesive, and through a cooling zone illustrated by cooling air blower 53 and the final non-woven, bi-axial, composite reinforcement fabric wound on final product roll 60, the product fabric having crossing layers of unidirectional fabric web, in this case at an angle of 90 degrees. Alternatively, the web 44 may be a previously cured and cooled roll of coated fabric and the curing step being effected on a flat surface or the like in which the tackiness of web 44 is not required in the layering process.

In the case of composite reinforcement fabrics employing fiberglass or carbon filament yarns or the like, a heated calendar roll may be employed for the handling of the fabrics since a severe angle around a small roller useful with a heating zone would damage those types of yarn. For these types of yarn, a flat heated surface is useful as a heating zone.

A finished composite article is constructed by (1) laying a first web portion of the non-woven, unidirectional, multi-axial fabric of the present invention on a supporting mold (2) applying a liquid resin of a polyester, epoxy, styrene, or vinyl ester to the first web portion so as to uniformly wet the fabric, (3) overlaying a second web portion of the non-woven, unidirectional, multi-axial fabric of the present invention upon the first web portion, (4) applying liquid resin to the second web portion so as to uniformly wet said fabric, (5) repeating the overlaying and liquid resin application steps to form a laid-up article of the thickness desired, and curing the laid-up article to form a finished composite article.

Alternatively, layers of pre-impregnated, dried and cooled intermediate webs may be cut as appropriate and laid at 0 degrees/90 degrees on a heated surface to form a bi-axial finished reinforcing fabric. This method is particularly useful for relatively brittle yarn filaments such as fiberglass and carbon filaments.

### EXAMPLE

An example of a polymer and liquid bath is Eastmans's WD-30 polyester. Polyester solids at a wt. percent level of 30% are suspended in water to form the polymer/liquid bath. These polyester solids are compatible with polyester resins and dissolve therein in the practice of the present invention. Other polymers which may be useful include epoxy polymer/liquid baths and epoxy resins, and phenolic polymer/liquid baths and phenolic resins.

Two types of fabric were manufactured on a pilot machine of van Wees, Tilburg, The Netherlands. The main characteristic of the pilot machine is that it has a 1,700 mm wide×541 mm diameter heated drum. The yarns were drawn from a creel, through a reed, through an impregnation roller(the polymer bath) for a adding a binder, and onto a heated Teflon-coated drum that was wrapped with the carrier. The yarns advanced by pitch (depending on the width of the yarn) as the yarns complete one revolution around the drum, and the individual filaments of the yarns laid side-by side until the yarns wrapped completely around the drum. The yarn/fabric was then cut perpendicular to the wrap around the drum, turned ninety, degrees, and re-attached to the drum. The process was than repeated to give a 0 degree/90 degree fabric. A table of process parameters follows:

Non-woven, Multi-axial, Unidirectional Fabric Information

Fabric Identification

| | S/295 | S/610 |
|---|---|---|
| Yarn information | | |
| Type | Fiberglass | Fiberglass |
| Yarn Size | ECDE75 | 247 yield |
| Number of yarn in creel | 10 | 1 |
| Tension, cN | Negligible | Negligible |
| Pitch, mm | 4.5 | 6.6 |
| Reed Information | | |
| Openings per 10 cm | 110 | N/A |
| Matrix Information | | |
| Type | None | WD-30 |
| Add-on, Percent | N/A | 1.0 |
| Carrier Information | | |
| Type | Pre-preg Web | Pre-preg Web |
| Density, g/sq · m | 3 | 3 |
| Drum Information | | |
| Circumferential Speed, m/min | 20 | 20 |
| Surface temp., degrees C. | 120 | 120 |
| Water Temp., degrees C. | 130 | 130 |
| Mass Information | | |
| Number of layers | 2 | 2 |
| Density of fabric, g/sq · m | 305 | 305 |

As can be seen from the table above, S/295 (which is the equivalent in weight and construction to the common fiberglass woven fabric, S/7782) did not have binder added to the yarns: only the pre-impregnated web (carrier) held the yarns together. This was done not only to demonstrate that binders do not have to necessarily used, but it was discovered that the binder was incompatible to the yarn finish and would not wet-out properly when the resin was applied. This demonstrated that a binder resulting in compatible yarn finishes must be chosen for specific resins.

In the case of actual manufacturing, the heated drum from the pilot process may be replaced by a heated calender or flat, heated Teflon-coated surface to flash-off the water from the binder.

In some applications, a single web of coated filament yarn cured with the netting material web is adequate as a composite reinforcement fabric and is within the scope of the present invention.

In some applications, the first and second coated filament yarn webs may be cured and employed as a reinforcement fabric without the netting web and is within the scope of the present invention.

In some applications, more than two coated filament yarn webs within a range of 0 degrees/90 degrees relative to each other may be cured employed as a reinforcement fabric and is within the scope of the present invention.

The filament yarns employed in the present invention preferably posses a tenacity exceeding 7.0 grams per denier, and are uncrimped.

Examples of articles which may be produced according to the present invention include sports equipment such as rackets and boat hulls, automobile panels, and aircraft wings and fuselage.

The laid-up article may be cured by any conventional means such as vacuum bag pressure and heat, or pressure autoclave to form the finished composite article.

It is to be understood that the present invention is not limited to the embodiments described above, but encompasses any and all embodiments within the scope of the following claims.

I claim:

1. A non-woven, unidirectional, multi-axial fabric for the reinforcement of composite structures, comprising:
a first layer of non-woven, unidirectional fabric web of filaments having a coating of polymeric adhesive upon said filaments thereof, said coating being of a low molecular weight polymer material; and
a second layer of non-woven, unidirectional fabric web of filaments having a coating of polymeric adhesive upon said filaments thereof and overlaid at an axial angle relative to said first layer of non-woven, unidirectional fabric, said polymeric adhesive coating of said first layer of fabric of fabric acting as an adhesive between said first layer of fabric and said second layer; and
a first netting layer web of filaments overlaid on said second layer of non-woven, unidirectional fabric, said netting layer adhering to said second layer by said adhesive coating thereon.
whereby, upon application of a liquid resin to said non-woven, unidirectional, multi-axial fabric, said liquid resin dissolves said adhesive coatings and wets said filaments of said first layer of fabric and said filaments of said second layer of fabric.

2. The reinforcement fabric of claim 1, wherein said netting material is one of woven and non-woven fabric, the spacing of the yarns in said netting material being within the range of about 5 mm to about 75 mm, and said netting material fabric being laid at angles ranging from 0 degrees to 90 degrees with respect to said second layer of non-woven, unidirectional fabric.

3. The reinforcement fabric of claim 2, wherein said coating on each said layer of non-woven, unidirectional fabric of filaments is a cured adhesive film of a low molecular weight polymer selected from the group comprising acrylic, polyester, and polyurethane polymers.

4. The reinforcement fabric of claim 3, wherein said filaments of said non-woven, unidirectional fabric are selected from the group comprising filaments of boron, carbon, and fiberglass, and aramid, nylon, PBO, PEN, polyester, and polyethylene polymers.

5. The reinforcement fabric of claim 4, further comprising a second netting layer of filaments laid on the underside of said first layer of non-woven, unidirectional fabric, said netting layer adhering to said second layer by said adhesive coating thereon.

6. The reinforcement fabric of claim 5, wherein said first and said second netting layers of filaments include filaments of fiberglass.

7. The reinforcement fabric of claim 6, wherein said axial angle of overlay of said second layer of non-woven, unidirectional fabric of filaments relative to said first layer of unidirectional fabric of filaments is about 90 degrees.

8. The reinforcement fabric of claim 1, wherein said adhesive coating comprises low molecular weight polyester and said resin is a polyester resin.

9. A method of forming a non-woven, unidirectional, multi-axial fabric for the reinforcement of composite structures comprising:
treating a first layer of non-woven, unidirectional fabric of filaments in a finish bath forming an adhesive coating thereon;
laying said treated first web of non-woven, unidirectional fabric of filaments on a flat support surface;
treating a second web of non-woven, unidirectional fabric of filaments in said finish bath forming a thin adhesive film thereon; and
overlaying said second web of non-woven, unidirectional fabric of filaments on said first web of non-woven, unidirectional fabric of filaments at an axial angle relative to said first web of non-woven, unidirectional fabric;
said adhesive coating bonding said second layer to said first layer forming a layered reinforcement fabric;
overlaying said second layer of non-woven, unidirectional fabric with a first netting layer of filaments, said netting layer adhering to said second layer by said adhesive coating thereon.

10. The method of forming a reinforcement fabric of claim 9, wherein first netting layer of filaments includes fiberglass filaments and the structure of said netting is formed by adhesion employing an adhesive coating of a low molecular weight polymer selected from the group comprising acrylic, polyester, and polyurethane polymers.

11. The method of forming a reinforcement fabric of claim 10, wherein said netting material is one of woven and non-woven fabric, the spacing of the yarns in said netting material being within the range of about 5 mm to about 75 mm, and said netting material fabric being laid at angles ranging from 0 degrees to 90 degrees with respect to said second layer of non-woven, unidirectional fabric.

12. The method of forming a reinforcement fabric of claim 11, wherein said yarns of said netting material are laid at an average angle of about 45 degrees with respect to said second layer of non-woven, unidirectional fabric.

13. The method of forming a reinforcement fabric of claim 12, wherein said filaments of said non-woven, unidirectional fabric are selected from the group comprising filaments of boron, carbon, and fiberglass, and aramid, nylon, PBO, PEN, polyester and polyethylene polymers.

14. The method of forming a reinforcement fabric of claim 9, wherein said adhesive coating is low molecular weight polyester.

15. The method of forming a reinforcement fabric of claim 14, wherein said second layer of non-woven, unidirectional fabric of filaments is overlaid on said first layer of non-woven, unidirectional fabric of filaments at an axial angle of 90 degrees relative to said first layer of non-woven, unidirectional fabric.

16. The method of forming a reinforcement fabric of claim 15, further comprising the step of under laying a second netting layer of fiberglass filaments on said first layer of non-woven, unidirectional fabric, said netting layer adhering to said second layer by said adhesive coating thereon.

17. A method of forming a finished composite article comprising;
laying a first web portion of the non-woven, unidirectional, multi-axial fabric of claim 4 on a supporting mold;
applying a liquid resin selected from the group comprising a polyester, epoxy, styrene, or vinyl ester to said first web portion so as to uniformly wet said fabric;
overlaying a second web portion of the non-woven, unidirectional, multi-axial fabric of claim 4 upon said first web portion;
applying said liquid resin to said second web portion so as to uniformly wet said fabric;
repeating said overlaying and said liquid resin application steps to form a laid-up article of the thickness desired; and
curing said laid-up article to form a finished composite article.

18. The method of claim 17, wherein said laid-up article is cured by vacuum bag pressure to form said finished composite article.

19. A composite article product made according to the method of claim 18.

20. The composite article product of claim 19 comprising polymerized polyester resin.
